(19) United States
(12) Patent Application Publication
(10) Pub. No.: US 2025/0239088 A1
(43) Pub. Date: Jul. 24, 2025

(54) IMAGE PROCESSING DEVICE

(71) Applicant: TOYOTA JIDOSHA KABUSHIKI KAISHA, Toyota-shi Aichi-ken (JP)

(72) Inventor: Ryusuke Kuroda, Edogawa-ku Tokyo-to (JP)

(73) Assignee: TOYOTA JIDOSHA KABUSHIKI KAISHA, Toyota-shi Aichi-ken (JP)

(21) Appl. No.: 19/032,495

(22) Filed: Jan. 21, 2025

(30) Foreign Application Priority Data
Jan. 24, 2024 (JP) 2024-008656

(51) Int. Cl. G06V 20/58; B60R 11/04; G06V 10/764

(52) U.S. Cl. CPC G06V 20/58; B60R 11/04; G06V 10/764

(57) ABSTRACT

An image processing device includes: a processor configured to: identify a camera to be prioritized among a plurality of cameras when a vehicle is traveling in a predetermined section, based on a priority information, set computing resources allocated to a predetermined processing on an image generated by each of the plurality of cameras so that an amount of computing resources allocated to the predetermined processing on an image generated by the camera to be prioritized is larger than an amount of computing resources allocated to the predetermined processing on an image generated by the other camera, and execute the predetermined processing on an image generated by each of the plurality of cameras so that the calculation amount of the predetermined processing increases as the amount of computing resources allocated increases.

### CROSS-REFERENCE TO RELATED APPLICATIONS

This application claims priority to Japanese Patent Application No. 2024-008656 filed Jan. 24, 2024, the entire contents of which are herein incorporated by reference.

### FIELD

The present disclosure relates to an image processing device that executes predetermined processing on an image obtained by a camera mounted on a vehicle.

### BACKGROUND

In a system capable of executing a plurality of processes, a technique of shortening the waiting time of a process having a higher priority has been proposed (see Japanese Unexamined Patent Publication JP2022-11822A).

The above-described document describes that a priority of object detection processing is set for an image obtained from each of a plurality of cameras mounted on a vehicle in accordance with a traveling state of the vehicle, and an object detection processing is executed by allocating computing resources to an image to be prioritized first.

### SUMMARY

Among a plurality of cameras mounted on a vehicle, a camera that can more appropriately capture an object to be detected may be switched to another camera according to a section in which the vehicle travels.

It is an object of the present disclosure to provide an image processing device capable of appropriately setting computing resources for executing a predetermined process on an image obtained from each of a plurality of cameras in a vehicle.

According to one embodiment, an image processing device is provided. The image processing device includes: a memory configured to store priority information indicating a camera to be prioritized in a predetermined section among a plurality of cameras that capture different areas around a vehicle; and a processor configured to: identify the camera to be prioritized among the plurality of cameras when the vehicle is traveling in the predetermined section, based on the priority information, set computing resources allocated to a predetermined processing on an image generated by each of the plurality of cameras so that an amount of computing resources allocated to the predetermined processing on an image generated by the camera to be prioritized is larger than an amount of computing resources allocated to the predetermined processing on an image generated by the other camera, and execute the predetermined processing on an image generated by each of the plurality of cameras so that the calculation amount of the predetermined processing increases as the amount of computing resources allocated increases.

In one embodiment, the predetermined section is a section in which a restricted vehicle speed in the section is equal to or lower than a predetermined threshold value, and the plurality of cameras includes a first camera whose capturing area is an area in front of the vehicle and a second camera whose capturing area is an area in front of the vehicle, the second camera having a wider angle than the first camera. The processor prioritizes the second camera rather than the first camera when the vehicle is traveling in the predetermined section.

In one embodiment, the predetermined processing is a process of detecting a predetermined object. The processor detects the predetermined object by inputting an image generated by the camera to be prioritized to a classifier trained in advance so as to detect the predetermined object, and executes down sampling or cropping an image generated by the other camera to detect the predetermined object by inputting the image which is down sampled or cropped to the classifier.

In one embodiment, the predetermined processing is a process of tracking a predetermined object. The processor sets a number of tracked objects among the plurality of predetermined objects represented in the image generated by the camera to be prioritized to be larger than a number of tracked objects among the plurality of predetermined objects represented in the image generated by the other camera.

In one embodiment, the arithmetic processing unit sets an execution cycle of the predetermined processing for the camera to be prioritized to be shorter than an execution cycle of the predetermined processing for the other camera.

The image processing device according to the present disclosure has an advantageous effect of appropriately setting computing resources for executing a predetermined process on an image obtained from each of a plurality of cameras in a vehicle.

### BRIEF DESCRIPTION OF DRAWINGS

FIG. 1 schematically illustrates the configuration of a vehicle control system equipped with an image processing device.

FIG. 2 illustrates the hardware configuration of an electronic control unit, which is an example of an image processing device.

FIG. 3 is a functional block diagram of a processor of an electronic control unit.

FIG. 4 is an explanatory diagram of an outline of resource allocation of each camera.

FIG. 5 is an operation flowchart of the vehicle control process including the image processing.

### DESCRIPTION OF EMBODIMENTS

Hereinafter, an image processing device, an image processing method executed in the image processing device, and an image processing computer program will be described with reference to the drawings. The image processing device specifies, among a plurality of cameras mounted on a vehicle, a camera (hereinafter, sometimes referred to as a prioritized camera) that is prioritized over other cameras when the vehicle is traveling in a predetermined section, based on priority information indicating a camera that is prioritized in the predetermined section. The image processing device sets computing resources to be allocated for executing a predetermined process on an image so that an amount of computing resources to be allocated for executing the predetermined process on an image generated by the prioritized camera is larger than an amount of computing resources to be allocated for executing the predetermined process on an image generated by another camera.

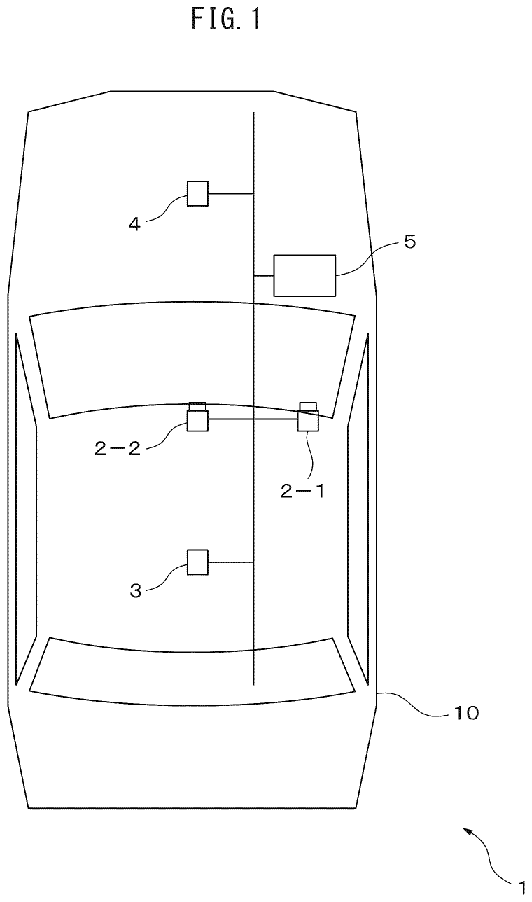

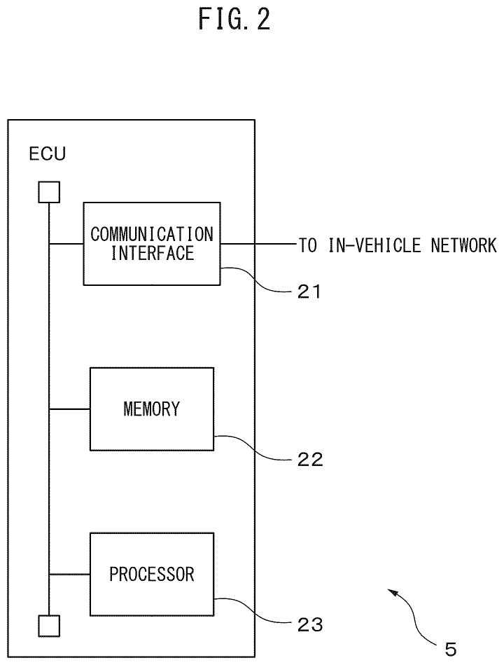

FIG. 1 schematically illustrates the configuration of a vehicle control system equipped with an image processing device. FIG. 2 is a hardware configuration diagram of an electronic control unit, which is an example of an image processing device. In the present embodiment, the vehicle control system I mounted on the vehicle 10 and controlling the vehicle 10 includes two cameras 2-1 to 2-2 for photographing the surroundings of the vehicle 10, a GPS receiver 3, a storage device 4, and an electronic control unit (ECU) 5 that is an example of an image processing device. The cameras 2-1 to 2-2, the GPS receiver 3, and the storage device 4 are communicably connected to the ECU 5 via an in-vehicle network. The vehicle control device 1 may further include a range sensor (not shown) that measures a distance to an object around the vehicle 10, such as LiDAR or radar.

Each of the cameras 2-1 to 2-2 is attached to the vehicle 10 so as to generate an image of different imaging areas around the vehicle 10. In the present embodiment, the camera 2-1 is an example of a first camera, and is a camera for generating an image of an area in front of the vehicle 10 and in a distance, has a relatively long focal length, and is mounted in the vehicle interior of the vehicle 10 toward the front of the vehicle 10. The camera 2-2 is an example of a second camera, and is a camera for generating an area in front of and vicinity the vehicle 10, and has a shorter focal length and a wider angle of view than the camera 2-1. That is, the camera 2-2 is a wider-angle camera than the camera 2-1. Similarly to the camera 2-1, the camera 2-2 is mounted in the vehicle interior of the vehicle 10 toward the front of the vehicle 10. Note that three or more cameras may be provided in the vehicle 10. For example, separate from the camera 2-1 and the camera 2-2, a camera for generating an image of an area behind the vehicle 10 or an area on either side of the left or right sides of the vehicle 10 may be provided. Each camera captures an imaging area of the camera every predetermined capturing cycle (for example, 1/30 seconds to 1/10 seconds), and generates an image in which the area is captured.

Each of the camera 2-1 and the camera 2-2 outputs the generated image together with the identification information of the camera to the ECU 5 via the in-vehicle network each time the image is generated.

The GPS receiver 3 receives GPS signals from GPS satellites at predetermined intervals, and determines the position of the vehicle 10 based on the received GPS signals. The GPS receiver 3 outputs, to the ECU 5 via the in-vehicle network, the positioning information indicating the result of determination of the position of the vehicle 10 based on GPS signal every time a positioning is performed. It should be noted that the vehicle 10 may include a receiver conforming to another satellite-based positioning system other than GPS receiver 3. In this case, the receiver may determine the position of the vehicle 10.

The storage device 4 is an example of a storage unit, and includes, for example, a hard disk device, a nonvolatile semiconductor memory, or an optical recording medium, and an access device thereof. Then, the storage device 4 stores map information. The map information includes, for each road segment, information indicating the position and range of the road segment, and priority information indicating the priority of each camera mounted on the vehicle 10 in the road segment, that is, the camera with the highest priority.

The ECU 5 executes autonomous driving control of the vehicle 10 or a vehicle control process for assisting driving of a driver of the vehicle 10. The vehicle control process includes predetermined processing on a plurality of time-series images obtained by each of the cameras 2-1 to 2-2. The ECU 5 includes a communication interface 21, a memory 22, and a processor 23. Note that the communication interface 21, the memory 22, and the processor 23 may be configured as different circuits or may be integrally configured as a single integrated circuit.

The communication interface 21 includes interface circuitry for connecting the ECU 5 to the in-vehicle networking. Each time the identification information and the image are received from the camera 2-1 or the camera 2-2, the communication interface 21 passes the received identification information and the image to the processor 23. The communication interface 21 passes the positioning information received from GPS receiver 3 and the map information received from the storage device 4 to the processor 23.

The memory 22 is another example of a storage unit, and includes, for example, a volatile semiconductor memory and a nonvolatile semiconductor memory. The memory 22 stores various types of data and parameters used in various processes executed by the processor 23 of the ECU 5. For example, the memory 22 stores map information, positioning information, and an image. Further, the memory 22 stores various types of data generated during the vehicle control process for a predetermined period of time, such as information about the detected object.

The processor 23 is an example of a control unit. In the present embodiment, the processor 23 includes, for example, one or more Central Processing Units (CPUs) and peripheral circuitry thereof. The processor 23 may further include another operating circuit, such as a logic-arithmetic unit, an arithmetic unit, or a graphics processing unit. Then, the processor 23 executes the vehicle control process for the vehicle 10.

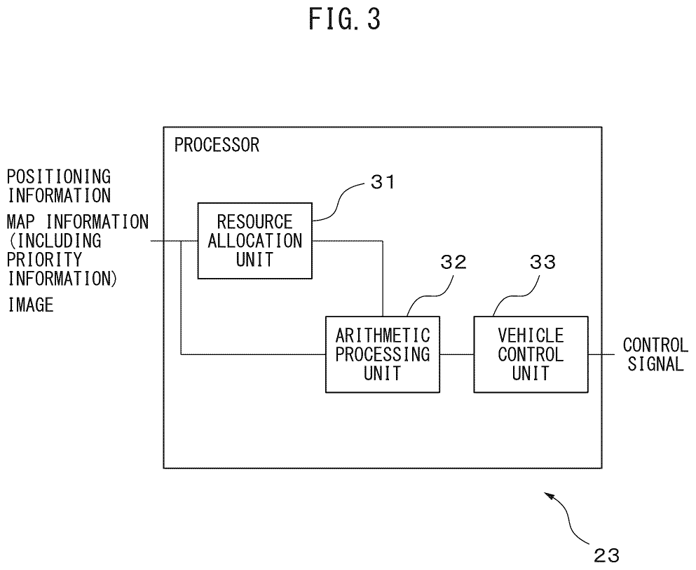

FIG. 3 is a functional diagram of the processor 23 of the ECU 5 for vehicle-control process including image processing. The processor 23 includes a resource allocation unit 31, an arithmetic processing unit 32, and a vehicle control unit 33. These units included in the processor 23 are functional modules implemented by a computer program executed by the processor 23, or may be dedicated operating circuits provided in the processor 23.

The resource allocation unit 31 refers to the priority information included in the map information for each predetermined cycle, and allocates computing resources to be used for a predetermined process executed by the arithmetic processing unit 32 to an image generated by each of the plurality of cameras mounted on the vehicle 10. In the present embodiment, the resource allocation unit 31 identifies the prioritized camera for the road section in which the vehicle 10 is traveling among the camera 2-1 and the camera 2-2, and allocates more computing resources to the image generated by the prioritized camera than the image generated by the other camera other than the prioritized camera.

For this purpose, the resource allocation unit 31 refers to the map information and the position of the vehicle 10 indicated by the latest positioning information by the GPS receiver 3, and thereby identifies the road section including the position of the vehicle 10. Then, the resource allocation unit 31 may identify the camera having the highest priority as the prioritized camera, based on the priority of each camera for the identified road section indicated in the priority information.

For example, it is assumed that the vehicle 10 travels at a relatively low speed in a road section with relatively many vulnerable road users. Therefore, it is required to reliably detect a vulnerable road user located in the vicinity of the vehicle 10 rather than in the distance of the vehicle 10. Therefore, for a road section with relatively many vulnerable road users, the camera 2-2 that captures a neighborhood area has a higher priority than the camera 2-1 that captures a distant area. Such a road section is set in advance based on the collected data representing the traffic situation. In some embodiments, the camera 2-2 that captures the neighborhood area has a higher priority than the camera 2-1 that captures the distant area even in a road section in which the limit vehicle speed is equal to or lower than a predetermined vehicle speed threshold (for example, 30 km/h) that is lower than the legal speed. Further, since the pedestrian is more likely to walk near the vehicle 10 even in the road section where there is no sidewalk, in some embodiments, the camera 2-2 that captures the neighborhood area has a higher priority than the camera 2-1 that captures the distant area.

Conversely, in a road section in which the vehicle 10 can travel at a relatively high speed, such as an expressway, it is required to detect an object that is likely to be an obstacle to traveling of the vehicle 10 (for example, another vehicle that is stopped in the host lane in which the vehicle 10 is traveling) as early as possible. Further, in a road section in which an intersection is visible at a distance, it is desirable to be able to detect a vulnerable road user passing through the intersection as early as possible, and it is required to improve the recognition accuracy of a traffic signal provided at the intersection. Therefore, with respect to a road section included in an expressway or a road section where an intersection is within a predetermined distance range (for example, several 10 m to 100 m), the camera 2-1 that captures a distant region has a higher priority than the camera 2-2 that captures a neighborhood region. When the vehicle 10 is closer to the intersection than the above-described distance range, the camera 2-2 may have a higher priority than the camera 2-1.

Note that, depending on the road section, the computing resources may be allocated to the respective cameras so as to be equal to each other.

The resource allocation unit 31 determines an allocation amount of computing resources for each camera so that the allocation amount of computing resources increase as the priority of the camera increases. At this time, the resource allocation unit 31 determines the allocation amount of the computing resources for each camera by referring to a reference table indicating the relationship between the priority and the allocation amount of the computing resources. The reference table may be stored in advance in the memory 22 or the storage device 4. Then, the resource allocation unit 31 notifies the arithmetic processing unit 32 of allocation information indicating the allocation amount of computing resources to each camera. The allocation information includes, for each camera, a combination of identification information of the camera and a flag having a larger value as the amount of computing resources allocated to the camera increases.

The arithmetic processing unit 32 uses the computing resources indicated by the allocation information notified from the resource allocation unit 31 to execute arithmetic operations for predetermined processing on images generated by individual cameras. That is, the arithmetic processing unit 32 executes predetermined processing on the images generated by the respective cameras such that the more amount of the allocated computing resources among the individual cameras, the larger the amount of arithmetic operation and the higher the accuracy. In the present embodiment, as a predetermined process, the arithmetic processing unit 32 executes a process for the vehicle 10 to avoid a collision with an object around the vehicle 10, specifically, an object detection process from an image. Further, the arithmetic processing unit 32 executes processing such as tracking of a detected object and prediction of a future trajectory of the object being tracked, which is associated with the object detection processing, as predetermined processing.

The arithmetic processing unit 32 detects a predetermined object represented in an image generated by individual camera by inputting the image to a classifier trained in advance so as to detect the predetermined object as object detection processing. The predetermined object is, for example, another vehicle around the vehicle 10, a pedestrian, a predetermined road sign such as a lane division line or a stop line, various road signs, traffic lights, or other objects that can affect the travel of the vehicle 10. Further, if the detected object is an object that can take a plurality of states, such as a traffic light, the classifier may be configured to also output an identification result of the state of the object. For example, if the detected object is a traffic light, the classifier is trained in advance to also output the lighting state of the traffic light, such as blue, yellow, and red.

The classifier used for object detection may be a so-called deep neural network (hereinafter simply referred to as DNN) having a convolutional neural network type architecture such as Single Shot MultiBox Detector or Faster R-CNN. Alternatively, the classifier may be DNN with attention mechanisms, such as Vision Transformer, or a classifier based on a machine learning method other than DNN. Such a classifier is trained in advance according to a predetermined learning method such as an error back propagation method using a large number of images (teacher images) representing an object to be detected.

In the present embodiment, an image generated by a prioritized camera having a relatively large allocation amount of computing resources (hereinafter, sometimes referred to as a priority image) is directly input to the classifier. On the other hand, an image (hereinafter, sometimes referred to as a “non-priority image”) generated by a camera having a relatively small allocation amount of computing resources (hereinafter, sometimes referred to as a “non-prioritized camera”) is downsized by down sampling and then input to the classifier. Alternatively, a predetermined region set in advance from the non-priority image may be cropped, and the cropped region may be input to the classifier. As described above, since the number of pixels of the image input to the classifier for the non-priority image is smaller than that of the original image, the calculation amount of the object detection processing for the non-priority image is smaller than the calculation amount of the object detection processing for the priority image. Alternatively, a classifier used for detecting the object from the priority image and a classifier used for detecting the object from the non-priority image may be provided separately. In this case, the classifier used for object detection from a priority image (hereinafter referred to as a precision classifier) may be a classifier having a relatively high detection accuracy of an object, although the calculation amount is relatively large. On the other hand, the classifier used for object detection from a non-priority image (hereinafter, referred to as a simple classifier) can be a classifier having a relatively small detection accuracy of an object but a relatively low calculation amount. For example, the number of arithmetic layers (for example, convolutional layers or attention mechanisms) included in the precision classifier, or the number of channels outputted from any of the layers is configured to be larger than that of the simple classifier.

For example, it is assumed that the road section in which the vehicle 10 is traveling is a road section with relatively many vulnerable road users, and the camera 2-2 that captures the neighborhood area is specified as the prioritized camera. In this case, the image generated by the camera 2-2 becomes a priority image and is input to the classifier as it is, so that a pedestrian or the like existing in the vicinity of the vehicle 10 is accurately detected. On the other hand, the image generated by the camera 2-1 becomes a non-priority image, and is downsampled or cropped and then input to the classifier, so that the detection of the object represented in the image is attempted with a relatively small amount of calculation.

In addition, for each camera, the arithmetic processing unit 32 tracks one or more objects detected from each of a plurality of images generated in time series by the camera as tracking processing. The object to be tracked may be a movable object, such as another vehicle or a pedestrian. However, the object to be tracked is not limited to a movable object, and may be an object whose state changes in time series such as a traffic light. At this time, the arithmetic processing unit 32 tracks the object by applying a predetermined tracking method such as KLT tracking to an object area in which the object detected from each of a plurality of images generated in time series is represented. As a result, object regions representing the same object are associated with each other between the respective images.

In the present embodiment, the number of objects to be tracked with respect to the plurality of priority images generated by the prioritized camera (hereinafter, sometimes referred to as the tracking upper limit number) is set to be larger than the tracking upper limit number with respect to the plurality of non-priority images generated by the non-prioritized camera. That is, the larger the amount of computing resources allocated, the more objects can be tracked. When the number of objects detected from the latest image exceeds the tracking upper limit number for any of the cameras, the arithmetic processing unit 32 selects an object to be tracked up to the tracking upper limit number in descending order of the object area in the latest image. This is because it is assumed that the larger the object area is, the closer the object represented in the object area to the vehicle 10. Alternatively, the arithmetic processing unit 32 may select an object to be tracked up to the tracking upper limit number in order from the lower end of the object region closer to the lower end of the latest image. This is because, in a case where the object to be tracked is an object on a road surface such as another vehicle or a pedestrian, it is assumed that the lower end of the object region in which the object is represented corresponds to a position where the object is in contact with the road surface, and the closer the lower end of the object region is to the lower end of the image, the closer the object represented in the object region to the vehicle 10.

Further, the arithmetic processing unit 32 executes a process of predicting a future trajectory of each object being tracked as the prediction process. For each object being tracked, the arithmetic processing unit 32 executes a viewpoint conversion process using information about a camera that generates a plurality of time-series images representing the object among the cameras provided in the vehicle 10 such as an attachment position, a focal length, and an angle of view. As a result, the arithmetic processing unit 32 converts the in-image coordinates of each object being tracked into coordinates on the bird's-eye image (bird's-eye coordinates), thereby obtaining the trajectory of the object. At this time, the arithmetic processing unit 32 can estimate the position of the detected object at the time of generating of each image, based on the position and orientation of the vehicle 10 at the time of generation of each image, the estimated distance to the detected object, and the direction from the vehicle 10 toward the object. Note that the arithmetic processing unit 32 can estimate the distance to the object on the basis of the position of the lower end of the object region representing the detected object on the image and parameters of the camera such as the photographing direction and the installation height. Further, in a case where a range sensor is mounted on the vehicle 10, the arithmetic processing unit 32 may use the distance measured by the range sensor for the azimuth corresponding to the object region in which the detected object is represented as the estimated distance to the object. In addition, the position and orientation of the vehicle 10 at the time of generating each image may be estimated by matching the image with the map information. At this time, the arithmetic processing unit 32 may project a predetermined feature such as a road marking detected from the image onto the map information by using the assumed position and orientation of the vehicle 10, and set the assumed position and orientation of the vehicle 10 when the projected feature and the corresponding feature represented in the map information most coincide with each other as the actual position and orientation of the vehicle 10. Then, the arithmetic processing unit 32 can estimate the predicted trajectory of the detected object up to a predetermined time-ahead by executing the prediction processing using a Kalman Filter, a Particle filter, or the like on the detected trajectory of the object.

In the present embodiment, the number of objects to be subjected to the prediction processing (hereinafter, sometimes referred to as a prediction upper limit number) for one or more objects detected from a plurality of priority images generated by the prioritized camera and being tracked is set more than the prediction upper limit number for one or more objects detected from a plurality of non-priority images generated by the non-prioritized camera and being tracked. That is, as the amount of computing resources allocated increases, the trajectory of many objects becomes predictable. In a case where the number of tracked objects exceeds the prediction upper limit number for any of the cameras, the arithmetic processing unit 32 may select an object to be predicted up to the prediction upper limit number in order from the closest approach position to the vehicle 10 in the tracked trajectory among the tracked objects.

Further, the execution cycle of the object detection processing and the related processing for the prioritized camera may be set to be shorter than the execution cycle of the object detection processing and the related processing for the non-prioritized camera. Each of the camera 2-1 and the camera 2-2 may change the exposure amount in a predetermined exposure cycle longer than the imaging cycle. For example, the exposure amount is changed in four steps for each exposure cycle. In this case, for the non-prioritized camera, the arithmetic processing unit 32 may use only the image generated with the specific exposure amount for the object detection processing and the related tracking processing. On the other hand, for the prioritized camera, the arithmetic processing unit 32 may use an image generated with a different exposure amount for the object detection process, the related tracking process, and the like. Thus, the execution cycle of the above-described processing for the prioritized camera is shorter than the execution cycle of the above-described processing for the non-prioritized camera. Even in a case where the shooting is always performed with a constant exposure amount for each camera, the arithmetic processing unit 32 may set the execution cycle of the object detection processing and the related processing for the prioritized camera to be relatively short. As a result, the arithmetic processing unit 32 executes the object detection processing and the related processing with respect to the prioritized camera at a shorter cycle, and thus can more precisely track and predict the action of the object represented in the image generated by the camera.

Note that the priority of each camera may be set to any one of three or more levels. In this case, as the priority set for the non-prioritized camera becomes lower, the arithmetic processing unit 32 may omit predetermined processing for the non-priority image. For example, the lower the priority, the lower the tracking upper limit number and the prediction upper limit number may be set. Alternatively, the arithmetic processing unit 32 may downsample or crop the non-priority image so that the number of pixels of the non-priority image input to the discriminator decreases as the priority becomes lower. Further, the arithmetic processing unit 32 may omit execute of the object detection processing and the related processing on the non-priority image generated by the non-prioritized camera having the lowest priority among the settable priorities.

The arithmetic processing unit 32 notifies the vehicle control unit 33 of the predicted trajectory of each object for which the predicted trajectory is obtained. Further, the arithmetic processing unit 32 notifies the vehicle control unit 33 of the type, state, and object region of each detected object in the latest image.

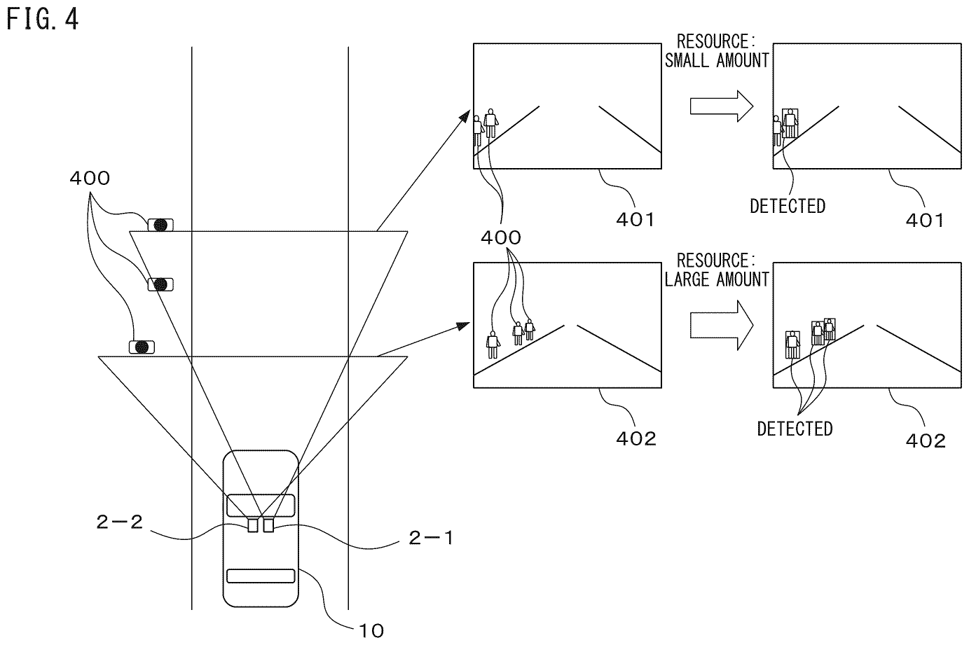

FIG. 4 is a diagram illustrating an example of allocation of computing resources to respective cameras according to the present embodiment. In this example, since it is assumed that a large number of pedestrians 400 exist in a road section in which the vehicle 10 is traveling, the camera 2-2 that captures a neighborhood area has a higher priority than the camera 2-1 that captures a distant area. Therefore, more computing resources are allocated to the image 402 generated by the camera 2-2 than the image 401 generated by the camera 2-1. As a result, a more precise object detection process is executed on the image 402 than on the image 401, so that the pedestrian 400 to be detected is more reliably detected from the image 402 than on the image 401.

When autonomously controlling the vehicle 10, the vehicle control unit 33 generates one or more scheduled trajectories of the vehicle 10 in the latest predetermined section (for example, 500 m to 1 km) so that the vehicle 10 travels along the travel scheduled route to the destination set by the navigation device (not shown). The scheduled trajectory is represented as, for example, a set of target positions of the vehicle 10 at each time when the vehicle 10 travels in a predetermined section. The vehicle control unit 33 controls each unit of the vehicle 10 so that the vehicle 10 travels along the scheduled trajectory.

Based on the predicted trajectory of each object being tracked, the vehicle control unit 33 generates a scheduled trajectory of the vehicle 10 such that the predicted value of the distance between each of the objects being tracked until the predetermined time and the vehicle 10 is equal to or more than the predetermined distance for any of the objects. Further, when a traffic light provided at an intersection in front of the vehicle 10 is a red signal, the vehicle control unit 33 generates a schedule trajectory such that the vehicle 10 stops before the intersection. The vehicle control unit 33 may generate a plurality of scheduled trajectories. In this case, the vehicle control unit 33 may select a path in which the sum of the absolute values of the acceleration of the vehicle 10 is the smallest among the plurality of scheduled trajectories.

When the scheduled trajectory is set, the vehicle control unit 33 controls each unit of the vehicle 10 so that the vehicle 10 travels along the scheduled trajectory. For example, the vehicle control unit 33 obtains the target acceleration of the vehicle 10 according to the scheduled trajectory and the current vehicle speed of the vehicle 10 measured by a vehicle speed sensor (not shown), and sets the accelerator opening degree or the brake amount so as to be the target acceleration. Then, the vehicle control unit 33 obtains the fuel injection amount according to the set accelerator opening degree, and outputs a control signal corresponding to the fuel injection amount to the fuel injection device of the engine of the vehicle 10. Alternatively, the vehicle control unit 33 obtains the amount of electric power supplied to the motor according to the set accelerator opening degree, and controls the drive circuit of the motor so that the amount of electric power is supplied to the motor. Alternatively, the vehicle control unit 33 outputs a control signal corresponding to the set brake amount to the brake of the vehicle 10.

In addition, when the course of the vehicle 10 is changed in order for the vehicle 10 to travel along the scheduled trajectory, the vehicle control unit 33 obtains the steering angle of the vehicle 10 according to the scheduled trajectory, and outputs a control signal according to the steering angle to an actuator (not shown) that controls the steering wheel of the vehicle 10.

In addition, in a case where driving of the driver is supported, the vehicle control unit 33 determines whether or not there is a possibility that the vehicle 10 collides with any object being tracked based on the predicted trajectory of each object being tracked and the predicted trajectory of the vehicle 10 in a case where the vehicle 10 continues traveling at the current vehicle speed and acceleration. When it is determined that there is a possibility of collision, the vehicle control unit 33 decelerates the vehicle 10. In addition, the vehicle control unit 33 may notify the driver that there is a risk of collision via a user interface provided in the vehicle interior of the vehicle 10. The user interface may be, for example, a display device, a speaker, a light source, or a vibrator.

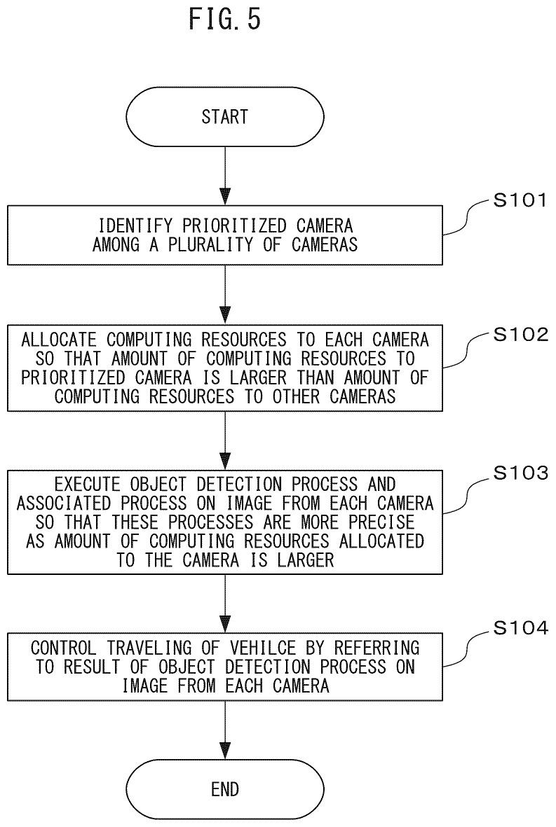

FIG. 5 is an operation flowchart of the vehicle control process including the image processing for the images of the respective cameras in the vehicle, which is executed by the processor 23.

The resource allocation unit 31 refers to the priority information included in the map information and identifies, among the plurality of cameras of the vehicle 10, the camera that are prioritized for the road section in which the vehicle 10 is traveling (step S101). Then, the resource allocation unit 31 allocates the computing resources to the cameras so that the amount of computing resources allocated to the prioritized camera is larger than the amount of computing resources allocated to other cameras (step S102).

For each camera, the arithmetic processing unit 32 executes an object detecting process and an associated process on the image generated by the camera so that these processes are more precise as the amount of computing resources allocated to the camera increases (step S103). Then, the vehicle control unit 33 controls the traveling of the vehicle 10 by referring to the result of object detecting process and the like for the images of the respective cameras (step S104).

As described above, the image processing device specifies the prioritized camera that is prioritized when the vehicle is traveling in the predetermined section, based on the priority information indicating the camera that is prioritized in the predetermined section among the plurality of cameras in the vehicle. The image processing device sets more computing resources to be allocated to the prioritized camera than computing resources to be allocated to other cameras, and executes predetermined processing on the images generated by the individual cameras using the allocated computing resources. As described above, the image processing device can appropriately set resources for executing predetermined processing for each of the plurality of cameras in the vehicle.

Note that the image processing according to the above-described embodiment or modification may be used for applications other than the vehicle control process. For example, the image processing may be executed to detect a predetermined feature such as a road marking or a road sign in each road section and upload information on the detected feature to a server via a wireless communication terminal mounted on a vehicle (not shown) in order to generate or update map information used for autonomous driving control. In this case, the processing of the vehicle control unit 33 may be omitted.

The computer program that achieves the functions of the processor 23 of the ECU 5 according to the above-described embodiment or modification may be provided in a form recorded on a computer-readable portable storage medium such as a semiconductor memory, a magnetic recording medium, or an optical recording medium.

As described above, a skilled person can make various modifications according to the embodiment within the scope of the present disclosure.

What is claimed is:

1. An image processing device comprising:
a memory configured to store priority information indicating a camera to be prioritized in a predetermined section among a plurality of cameras that capture different areas around a vehicle; and
a processor configured to:
identify the camera to be prioritized among the plurality of cameras when the vehicle is traveling in the predetermined section, based on the priority information,
set computing resources allocated to a predetermined processing on an image generated by each of the plurality of cameras so that an amount of computing resources allocated to the predetermined processing on an image generated by the camera to be prioritized is larger than an amount of computing resources allocated to the predetermined processing on an image generated by the other camera, and
execute the predetermined processing on an image generated by each of the plurality of cameras so that a calculation amount of the predetermined processing increases as the amount of computing resources allocated increases.

2. The image processing device according to claim 1, wherein the predetermined section is a section in which a restricted vehicle speed in the section is equal to or lower than a predetermined threshold value, and the plurality of cameras includes a first camera whose capturing area is an area in front of the vehicle and a second camera whose capturing area is an area in front of the vehicle, the second camera having a wider angle than the first camera, wherein
the processor prioritizes the second camera rather than the first camera when the vehicle is traveling in the predetermined section.

3. The image processing device according to claim 1, wherein the predetermined processing is a process of detecting a predetermined object, wherein
the processor detects the predetermined object by inputting an image generated by the camera to be prioritized to a classifier trained in advance so as to detect the predetermined object, and executes down sampling or cropping an image generated by the other camera to detect the predetermined object by inputting the image which is down sampled or cropped to the classifier.

4. The image processing device according to claim 1, wherein the predetermined processing is a process of tracking a predetermined object, wherein
the processor sets a number of tracked objects among the plurality of predetermined objects represented in the image generated by the camera to be prioritized to be larger than a number of tracked objects among the plurality of predetermined objects represented in the image generated by the other camera.

5. The image processing device according to claim 1, wherein the processor sets an execution cycle of the predetermined processing for the camera to be prioritized to be shorter than an execution cycle of the predetermined processing for the other camera.
